(19) United States
(12) Patent Application Publication
(10) Pub. No.: US 2025/0265820 A1
(43) Pub. Date: Aug. 21, 2025

(54) METHOD AND SYSTEM FOR GENERATING VISUAL FEATURE MAP USING THREE-DIMENSIONAL MODEL AND STREET VIEW IMAGE

(71) Applicant: NAVER CORPORATION, Seongnam-si (KR)

(72) Inventors: Junho Jeon, Seongnam-si (KR); Wonjune Cho, Seongnam-si (KR); Sujung Kim, Seongnam-si (KR); Mooyeol Baek, Seongnam-si (KR)

(21) Appl. No.: 19/201,605

(22) Filed: May 7, 2025

Related U.S. Application Data
(63) Continuation of application No. PCT/KR2023/017704, filed on Nov. 6, 2023.

(30) Foreign Application Priority Data
Nov. 8, 2022 (KR) 10-2022-0147616

(51) Int. Cl. G06V 10/77; G06T 7/50; G06T 7/73; G06T 17/05; G06V 10/26; G06V 10/44; G06V 10/74; G06V 20/56

(52) U.S. Cl. CPC G06V 10/7715; G06T 7/50; G06T 7/75; G06T 17/05; G06V 10/26; G06V 10/443; G06V 10/761; G06V 20/56

(57) ABSTRACT

A method for generating a visual feature map including: receiving a 3-D model for a specific area including 3-D geometric information expressed in absolute coordinate positions; receiving a first street view image captured at a first node within the specific area; rendering a depth map associated with the first street view image by projecting at least a part of the 3-D geometric information onto the first street view image; extracting a first set of feature points from the first street view image; determining, on the basis of the depth map, absolute coordinate position information of at least some of the first set of feature points; and generating a first visual feature map associated with the first street view image by storing, for each feature point in the first set, the absolute coordinate position information and a visual feature descriptor in association with each other.

The present application claims priority to International Application No. PCT/KR2023/017704, filed on Nov. 6, 2023, the entire contents of which are hereby incorporated herein by reference for all purposes.

### BACKGROUND OF THE INVENTION

The present invention relates to a method and system for generating a visual feature map using a three-dimensional model and a street view image and, more specifically, to a method and system for automatically generating a visual feature map using a street view image aligned with absolute coordinate position information of a three-dimensional model.

Autonomous driving technology relates to technology that enables a vehicle to drive autonomously with minimal or no human intervention by recognizing the surrounding environment using radar, LIDAR (light detection and ranging), GPS (global positioning system), cameras, and the like attached to the vehicle. Since the driving environment has various factors that affect autonomous driving, such as vehicles in the road area, traffic structures, and buildings in the roadside area, accurately recognizing the surrounding environment of the vehicle using devices attached to the vehicle is an important factor in securing safety for commercialization of autonomous driving technology.

In order to accurately recognize the surrounding environment of the vehicle, it is essential to generate a visual feature map of the driving environment using image information from the viewpoint of an autonomous vehicle with precise three-dimensional geometric information and position information. However, in order to acquire three-dimensional geometric information and image information, it is necessary to acquire mapping data for the target area using a vehicle equipped with a vehicle-based multi-sensor surveying system (Mobile Mapping System, MMS) including an expensive lidar sensor, camera, and high-precision GPS. However, this requires driving the vehicle directly to the area where data acquisition is required, which requires cost and effort.

In addition, a method of generating a visual feature map using street view images captured to provide street view services was also considered, but there is a problem in which the location information obtained using GPS equipment of the vehicle when capturing street view images has an error of about 5 to 10 meters. To resolve this inaccuracy of location information, street view images may be taken while obtaining high-precision location information by mounting expensive GPS equipment to the vehicle, but this incurs a high cost, and there is a problem in which street view images previously captured cannot be utilized.

The present disclosure provides a method, a non-transitory computer-readable recording medium recording instructions, and a device (system) for solving the above problems.

### BRIEF SUMMARY OF THE INVENTION

The present invention may be implemented in various ways including as a method, a device (system), or a non-transitory computer-readable recording medium with instructions recorded thereon.

According to one embodiment of the present invention, a method for generating a visual feature map using a three-dimensional model and a street view image, performed by at least one processor, includes receiving a three-dimensional model for a specific area including three-dimensional geometric information expressed as absolute coordinate positions, receiving a first street view image captured at a first node within the specific area, projecting at least some of the three-dimensional geometric information included in the three-dimensional model onto the first street view image, based on absolute coordinate position information and direction information of the first street view image, to render a depth map associated with the first street view image, extracting a first set of feature points from the first street view image, determining absolute coordinate position information of all or some of the first set of feature points, based on the depth map, and generating a first visual feature map associated with the first street view image by storing, for each of the feature points in the first set, the absolute coordinate position information and a visual feature descriptor in association with each other.

There is provided a non-transitory computer-readable recording medium with instructions recorded thereon for executing a method according to an embodiment of the present invention on a computer.

According to an embodiment of the invention, an information processing system includes a communication module, a memory, and at least one processor connected to the memory and configured to execute at least one computer-readable program included in the memory, and the at least one program includes instructions for receiving a three-dimensional model for a specific area including three-dimensional geometric information expressed as absolute coordinate positions, receiving a first street view image captured at a first node within the specific area, projecting at least some of the three-dimensional geometric information included in the three-dimensional model onto the first street view image, based on absolute coordinate position information and direction information of the first street view image, to render a depth map associated with the first street view image, extracting a first set of feature points from the first street view image, determining absolute coordinate position information of all or some of the first set of feature points, based on the depth map, and generating a first visual feature map associated with the first street view image by storing, for each of the feature points in the first set, the absolute coordinate position information and a visual feature descriptor in association with each other.

According to certain embodiments of the present invention, three-dimensional building model information generated through aerial image surveying or the like and street view images previously taken for street view services may be used, instead of using a vehicle equipped with a vehicle-based multi-sensor surveying system, thereby reducing the cost and effort for obtaining a visual feature map.

According to certain embodiments of the invention, objects related to autonomous driving may be extracted from multiple pieces of environmental information included in a street view image using a binary mask, and a visual feature map thereof may be generated, thereby improving the quality of the visual feature map.

The advantageous effects of the present invention are not limited to the effects mentioned above, and other effects not mentioned may be clearly understood by those skilled in the art to which the disclosure pertains (referred to as “ordinary technicians”) from the description of the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The embodiments of the invention will be described with reference to the accompanying drawings, wherein like reference numerals represent like elements, but are not limited thereto.

FIG. 1 is a drawing illustrating an example of a method for aligning a three-dimensional model and street view data according to an embodiment of the invention.

FIG. 2 is a schematic diagram illustrating a configuration in which an information processing system is connected to a plurality of user terminals for communication according to an embodiment of the invention.

FIG. 3 is a block diagram illustrating the internal configuration of a user terminal and an information processing system according to an embodiment of the invention.

FIG. 4 is a drawing illustrating an example of a process for generating a visual feature map associated with a street view image, based on a three-dimensional model and a street view image, according to an embodiment of the invention. e

FIG. 5 is a block diagram illustrating a specific method for generating a visual feature map associated with a first street view image, based on aligned street view data and a three-dimensional model, according to an embodiment of the invention.

FIG. 6 is a block diagram illustrating a specific method for generating a visual feature map associated with a first street view image, based on aligned street view data, a three-dimensional model, a binary mask, and three-dimensional planar information about road traffic structures, according to another embodiment of the invention.

FIG. 7 is a diagram illustrating an example of a process for generating a binary mask, based on a street view image, according to an embodiment of the disclosure.

FIG. 8 is a diagram illustrating an example of a process for performing stereo matching for road traffic structures in a first street view image and a second street view image according to an embodiment of the invention.

FIG. 9 is an example of a three-dimensional planar information map for a plurality of road traffic structures according to an embodiment of the invention.

FIG. 10 is an example of a process for extracting a first set of feature points from a street view image using a plurality of planar images generated based on a street view image according to an embodiment of the invention.

FIG. 11 is an example of a process for obtaining absolute coordinate position information for road traffic structures according to an embodiment of the invention.

FIG. 12 illustrates an example of a visual feature map for a specific area according to an embodiment of the invention.

FIG. 13 is a flowchart illustrating an example of a method for generating a visual feature map using a three-dimensional model and a street view image according to an embodiment of the invention.

### DETAILED DESCRIPTION OF THE INVENTION

Hereinafter, specific details for the implementation of the present invention will be described in detail with reference to the attached drawings. However, in the following description, specific descriptions of widely known functions or configurations that may unnecessarily obscure the subject matter of the disclosure, will be omitted.

In the attached drawings, identical or corresponding components are given the same reference numerals. In addition, redundant descriptions of identical or corresponding components may be omitted from the description of the embodiments described below. However, even if the description of a component is omitted, it is not intended that such a component is not included in any embodiment.

The advantages and features of the disclosed embodiments, and the methods for attaining them will become clear with reference to the embodiments described below together with the attached drawings. However, the disclosure is not limited to the embodiments disclosed below, and may be implemented in various different forms, and the embodiments are provided only to make the disclosure complete and to fully inform ordinary technicians of the scope of the invention.

The terms used in this specification will be briefly explained, and the disclosed embodiments will be described in detail. Although the terms used in this specification are selected from widely used and current terms, considering the functions in the disclosure, these may vary depending on the intentions of technicians in the relevant field, precedents, introduction of new technologies, or the like. In addition, in certain cases, there are terms arbitrarily selected by the applicant, and in such cases, their meanings will be described in detail in the description of the relevant disclosure. Therefore, the terms used in the disclosure should be defined based on the meaning of the terms and the overall content of the disclosure, instead of simply based on the names of the terms.

In this specification, singular expressions include plural expressions unless the context clearly specifies that they are singular. In addition, plural expressions include singular expressions unless the context clearly specifies that they are plural. In the case where a part includes a component through the specification, this indicates that another component may be further included, instead of being excluded, unless otherwise specifically stated.

In addition, the term “module” or “unit” used in the specification indicates a software or hardware component, and the “module” or “unit” performs a certain role. However, the “module” or “unit” is not limited to software or hardware. The “module” or “unit” may be configured to reside in an addressable storage medium or may be configured to execute on one or more processors. Thus, for example, the “module” or “unit” may include at least one of components such as software components, object-oriented software components, class components, and task components, processes, functions, properties, procedures, subroutines, segments of program code, drivers, firmware, microcode, circuits, data, databases, data structures, tables, arrays, or variables. Components and functions provided from the “module” or “unit” may be combined into a smaller number of components and “modules” or “units” or may be further separated into additional components and “modules” or “units”.

According to an embodiment of the disclosure, the “module” or “unit” may be implemented as a processor and a memory. The “processors” should be interpreted broadly to include general-purpose processors, central processing units (CPUs), microprocessors, digital signal processors (DSPs), controllers, microcontrollers, and state machines. In some environments, the “processors” may also indicate application-specific integrated circuits (ASICs), programmable logic devices (PLDs), field-programmable gate arrays (FPGAs), and the like. The “processor” may also indicate a combination of processing devices, such as a combination of a DSP and a microprocessor, a combination of multiple microprocessors, a combination of one or more microprocessors in conjunction with a DSP core, or a combination of any other such configurations. In addition, the “memory” should be interpreted broadly to include any electronic component capable of storing electronic information. The “memory” may also indicate various types of processor-readable media, such as random-access memory (RAM), read-only memory (ROM), non-volatile random-access memory (NVRAM), programmable read-only memory (PROM), erasable programmable read-only memory (EPROM), electrically erasable PROM (EEPROM), flash memory, magnetic or optical data storage devices, registers, or the like. The memory may be regarded as being in electronic communication with a processor if the processor may read information from the memory and/or write information in the memory. A memory integrated into a processor is in electronic communication with the processor.

In the disclosure, a “system” may include, but is not limited to, at least one of a server device and a cloud device. For example, the system may be configured as one or more server devices. As another example, the system may be configured as one or more cloud devices. As another example, the system may be configured and operated with a server device and a cloud device.

In the disclosure, a “display” may indicate any display device associated with a computing device, for example, any display device capable of displaying any information/data controlled or provided by the computing device.

In the disclosure, “each of a plurality of As” may indicate each of all components included in the plurality of As, or each of some components included in the plurality of As.

In the disclosure, “street view data” may indicate data including not only road view data including images captured on a roadway and location information but also walk view data including images captured on a sidewalk and location information. In addition, “street view data” may further include images captured at any point outdoors (or indoors facing outdoors) in addition to the roadways and sidewalks.

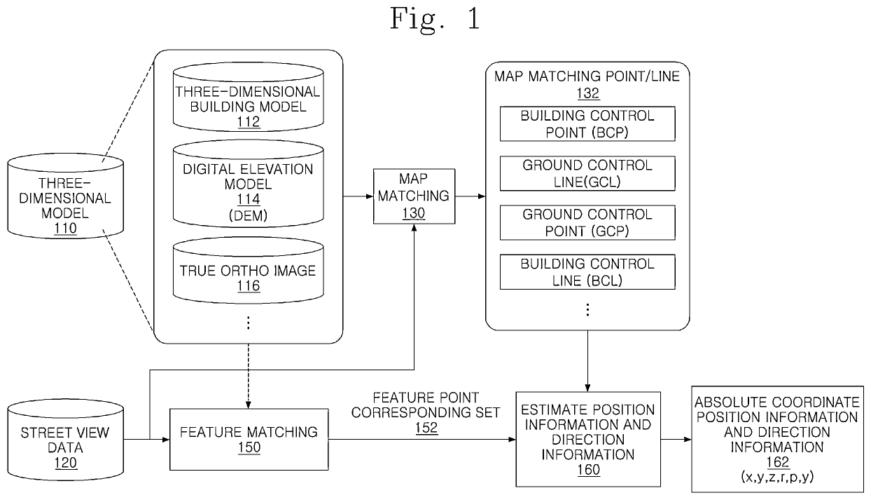

FIG. 1 is a drawing illustrating an example of a method for aligning a three-dimensional model 110 and street view data 120 according to an embodiment of the invention. An information processing system may obtain/receive a three-dimensional model 110 and street view data 120 for a specific area.

The three-dimensional model 110 may include three-dimensional geometric information expressed as absolute coordinate positions and texture information corresponding thereto (where the texture information of a 3D model is a 2D image that provides various information such as color, texture, and pattern to the surface of the model. Such texture is an important element that determines the appearance of a 3D model and plays a role in enhancing realism and expressiveness). Here, the position information included in the three-dimensional model 110 may be information with higher accuracy than the position information included in the street view data 120. In addition, the texture information included in the three-dimensional model 110 may be information with lower quality (e.g., lower resolution) than the texture information included in the street view data 120. According to certain embodiments, the three-dimensional geometric information expressed as absolute coordinate positions may be generated based on aerial photographs of a specific area taken from above the specific area.

The three-dimensional model 110 for a specific area may include a three-dimensional building model 112, a digital elevation model (DEM) 114, a true ortho image 116 for a specific area, a digital surface model (DSM), a road layout, a road DEM, and the like. As a specific example, the three-dimensional model 110 for a specific area may be a model generated based on a digital surface model (DSM) including geometric information about the ground surface of the specific area and a true ortho image 116 for the specific area corresponding thereto, but it is not limited thereto. In certain embodiments, a precise true ortho image 116 of the specific area may be generated based on a plurality of aerial photographs and absolute coordinate position information and direction information of each aerial photograph.

The street view data 120 may include a plurality of street view images captured at a plurality of nodes within the specific area and absolute coordinate position information for each of the plurality of street view images (where a node indicates a specific point within a specific area where street view images were captured). Here, the position information included in the street view data 120 may be information with lower accuracy than the position information included in the three-dimensional model 110, and the texture information included in the street view image may be information with higher quality (e.g., higher resolution) than the texture information included in the three-dimensional model 110. For example, the position information included in the street view data 120 may be position information obtained using a GPS device when capturing a street view image at a node. The position information obtained using the vehicle's GPS device may have an error of about 5 to 10 meters. Additionally, the street view data may include direction information (i.e., image capturing direction information) for each of a plurality of street view images.

The information processing system may perform map matching 130 between the three-dimensional model 110 and the street view data 120. Specifically, the information processing system may perform feature matching between the texture information included in the three-dimensional model 110 and a plurality of street view images included in the street view data 120. To perform map matching 130, the information processing system may convert at least some of the plurality of street view images included in the street view data 120 into top view images. As a result of map matching 130, a plurality of map matching points/map matching lines 132 may be extracted.

The map matching point may represent a corresponding pair of a point of a street view image and a point of a three-dimensional model 110. The type of map matching point may vary depending on the type of the three-dimensional model 110 used for map matching 130, the position of the point, or the like. For example, the map matching point may include at least one of a ground control point (GCP), which forms a corresponding pair with a point on the ground within a specific area, a building control point (BCP), which forms a corresponding pair with a point on a building within a specific area, or a structure control point, which forms a corresponding pair with a point on a structure within a specific area. The map matching point may be extracted from any area of the street view image and the three-dimensional model 110, as well as from the ground, buildings, and structures described above.

The map matching line may represent a corresponding pair of a line of the street view image and a line of the three-dimensional model 110. The type of the map matching line may vary depending on the type of the three-dimensional model 110 used for map matching 130, the position of the line, or the like. For example, the map matching line may include at least one of a ground control line (GCL), which forms a corresponding pair with a line on the ground within a specific area, a building control line (BCL), which forms a corresponding pair with a line on a building within a specific area, a structure control line, which forms a corresponding pair with a line on a structure within a specific area, or a lane control line, which forms a corresponding pair with a line on a lane within a specific area. The map matching line may be extracted from any area of the street view image and the three-dimensional model 110, as well as from the ground, buildings, structures, and lanes described above.

In addition, the information processing system may perform feature matching 150 between a plurality of street view images to extract a plurality of feature point corresponding sets 152. In some embodiments, for robust feature matching, feature matching 150 may be performed between a plurality of street view images using at least a part of the three-dimensional model 110. For example, feature matching 150 may be performed between the street view images using a three-dimensional building model 112 included in the three-dimensional model 110.

Then, as depicted in box 160, the information processing system may estimate absolute coordinate position information and direction information for the plurality of street view images on the basis of at least one of the plurality of map matching points/map matching lines 132 and at least a part of the plurality of feature point correspondence sets 152. For example, in box 160, the processor may estimate absolute coordinate position information and direction information for the plurality of street view images using a bundle adjustment technique. According to an embodiment, the estimated absolute coordinate position information and direction information 162 may be information of an absolute coordinate system expressing the three-dimensional model 110 and may be parameters of 6 degrees of freedom (DoF). The absolute coordinate position information and direction information 162 estimated through the above process may be data with higher precision than the absolute coordinate position information and direction information included in the street view data 120.

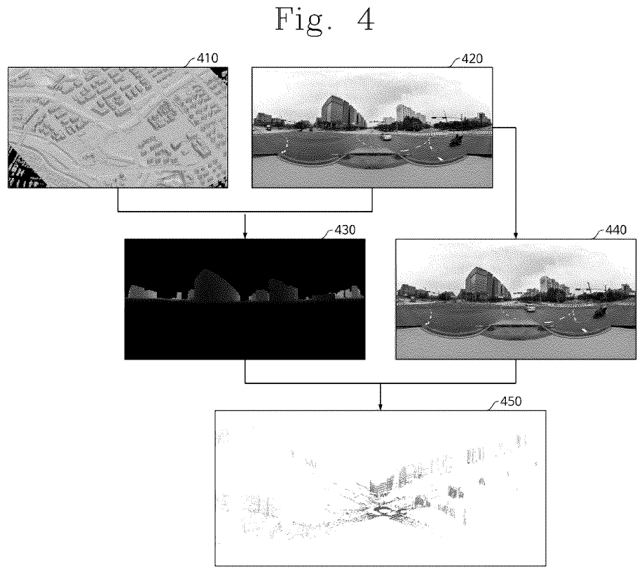

According to certain embodiments of the invention, a visual feature map for each street view image in the street view data aligned with the absolute coordinate position information of the three-dimensional model may be automatically generated using at least one of the predefined map matching points/map matching lines 132 and using the three-dimensional model 110. A method for generating a visual feature map for a street view image will be described later with reference to FIGS. 4 to 13. By this configuration, the cost and effort for generating a visual feature map for map-based services such as autonomous driving may be reduced. In addition, the automatically generated visual feature map may be utilized in various map-based services such as autonomous driving services.

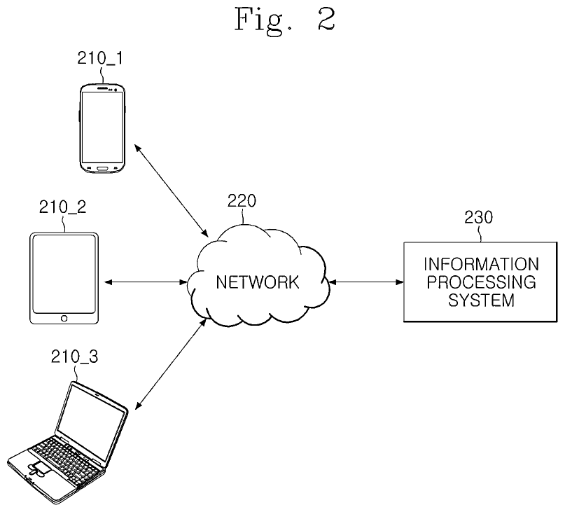

FIG. 2 is a schematic diagram illustrating a configuration in which an information processing system 230 is connected to a plurality of user terminals 210_1, 210_2, and 210_3 for communication according to certain embodiments of the invention. As illustrated, a plurality of user terminals 210_1, 210_2, and 210_3 may be connected to an information processing system 230 capable of providing map information services through a network 220. Here, the plurality of user terminals 210_1, 210_2, and 210_3 may include terminals of users who receive map information services, autonomous driving services, or the like. Additionally, the plurality of user terminals 210_1, 210_2, and 210_3 may be associated with vehicles that capture street view images from nodes. In some embodiments, the information processing system 230 may include one or more server devices and/or databases or one or more distributed computing devices and/or distributed databases based on cloud computing services capable of storing, providing, and executing computer-executable programs (e.g., downloadable applications) and data related to providing map information services.

The map information services provided by the information processing system 230 may be provided to users through applications or web browsers installed on each of the plurality of user terminals 210_1, 210_2, and 210_3. For example, the information processing system 230 may provide information corresponding to street view image requests or image-based localization requests received from the user terminals 2101, 210_2, and 210_3 through applications, or may perform processing corresponding thereto.

The plurality of user terminals 210_1, 210_2, and 210_3 may communicate with the information processing system 230 through the network 220. The network 220 may be configured to enable communication between the plurality of user terminals 2101, 210_2, and 210_3 and the information processing system 230. Depending on the installation environment, the network 220 may be configured as a wired network such as an Ethernet, a wired home network (Power Line Communication), a telephone line communication device, and RS-serial communication, or as a wireless network such as a mobile communication network, a WLAN (Wireless LAN), Wi-Fi, Bluetooth, and ZigBee, or a combination thereof. The communication method is not limited, and may include not only a communication method utilizing a communication network (for example, mobile communication network, wired Internet, wireless Internet, broadcasting network, satellite network, or the like) for the network 220, but may also include short-range wireless communication between the user terminals 2101, 210_2, and 210_3.

Although a mobile phone terminal 210_1, a tablet terminal 2102, and a PC terminal 210_3 are illustrated as examples of user terminals in FIG. 2, the user terminals 2101, 210_2, and 210_3 are not limited thereto, and may be any type of computing device capable of wired and/or wireless communication and that is also capable of installing and executing an application or web browser. For example, the user terminal may be any one of an AI speaker, a smartphone, a mobile phone, a navigation device, a computer, a laptop, a digital broadcasting terminal, a PDA (Personal Digital Assistants), a PMP (Portable Multimedia Player), a tablet PC, a game console, a wearable device, an IoT (Internet-of-Things) device, a VR (Virtual Reality) device, an AR (Augmented Reality) device, a set-top box, or the like. In addition, although FIG. 2 illustrates those three user terminals 210_1, 210_2, and 210_3 communicate with the information processing system 230 through the network 220, the invention is not limited thereto, and a different number of user terminals may be configured to communicate with the information processing system 230 through the network 220.

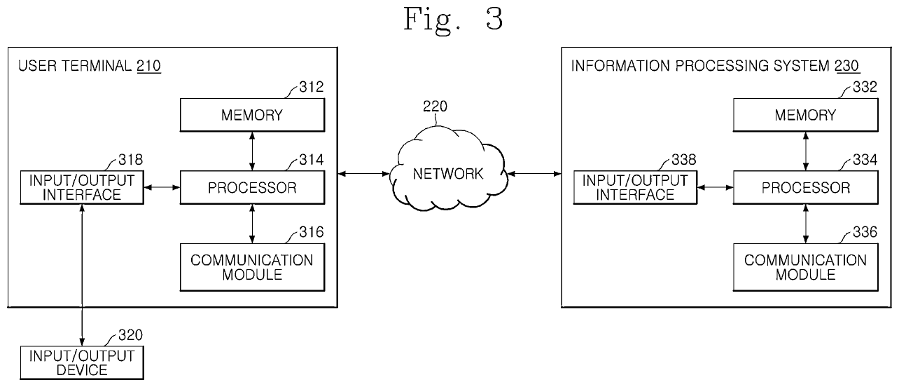

FIG. 3 is a block diagram illustrating the internal configuration of a user terminal 210 and an information processing system 230 according to an embodiment of the invention. The user terminal 210 may comprise any computing device capable of executing an application or web browser and that is also capable of wired/wireless communication, and may include, for example, the mobile phone terminal 2101, the tablet terminal 210_2, and the PC terminal 210_3 in FIG. 2. As illustrated, the user terminal 210 may include a memory 312, a processor 314, a communication module 316, and an input/output interface 318. Similarly, the information processing system 230 may include a memory 332, a processor 334, a communication module 336, and an input/output interface 338. As illustrated in FIG. 3, the user terminal 210 and the information processing system 230 may be configured to transmit and receive information and/or data through the network 220 using their respective communication modules 316 and 336. In addition, an input/output device 320 may be configured to input information and/or data to the user terminal 210 or output information and/or data generated from the user terminal 210 through the input/output interface 318.

The memory 312 or 332 may comprise any type of non-transitory computer-readable recording medium. According to some embodiments, the memory 312 or 332 may include a permanent mass storage device such as a read-only memory (ROM), a disk drive, a solid-state drive (SSD), a flash memory, or the like. As another example, a permanent mass storage device such as a ROM, an SSD, a flash memory, or a disk drive may be included in the user terminal 210 or in the information processing system 230 as a separate permanent storage device distinct from the memory. In addition, the memory 312 or 332 may store an operating system and at least one program code (e.g., code for an application installed and run on the user terminal 210).

The software components described above may be loaded from a computer-readable recording medium separate from the memory 312 or 332. The separate computer-readable recording medium may include a recording medium directly connectable to the user terminal 210 and the information processing system 230, for example, a computer-readable recording medium such as a floppy drive, a disk, a tape, a DVD/CD-ROM drive, or a memory card. As another example, the software components may be loaded into the memory 312 or 332 through a communication module other than a computer-readable recording medium. For example, at least one program may be loaded into the memory 312 or 332, based on a computer program installed by files provided by developers or a file distribution system distributing installation files of the application through the network 220.

The processor 314 or 334 may be configured to process instructions of a computer program by performing basic arithmetic, logic, and input/output operations. The instructions may be provided to the processor 314 or 334 by the memory 312 or 332 or by the communication module 316 or 336. For example, the processor 314 or 334 may be configured to execute the received instructions according to program code stored in a recording device such as the memory 312 or 332.

The communication module 316 or 336 may provide a configuration or function for the user terminal 210 and the information processing system 230 to communicate with each other through the network 220, and may provide a configuration or function for the user terminal 210 and/or the information processing system 230 to communicate with another user terminal or another system (e.g., a separate cloud system or the like). For example, a request or data (e.g., data related to a street view image taken from the ground) generated by the processor 314 of the user terminal 210 according to a program code stored in a recording device such as the memory 312 may be transmitted to the information processing system 230 through the network 220 under the control of the communication module 316. Conversely, a control signal or instruction provided under the control of the processor 334 of the information processing system 230 may be received by the user terminal 210 through the communication module 316 of the user terminal 210 via the communication module 336 and the network 220. For example, the user terminal 210 may receive data related to a street view image for a specific area from the information processing system 230.

The input/output interface 318 may be a means for interfacing with the input/output device 320. For example, the input device may include a device such as a camera including an audio sensor and/or an image sensor, a keyboard, a microphone, a mouse, and the like, and the output device may include a device such as a display, a speaker, a haptic feedback device, or the like. As another example, the input/output interface 318 may be a means for interfacing with a device that has integrated configurations or functions for performing both input and output, such as a touch screen. For example, when the processor 314 of the user terminal 210 processes an instruction of a computer program loaded into the memory 312, a service screen or the like, which is configured using information and/or data provided by the information processing system 230 or another user terminal, may be displayed on a display through the input/output interface 318. Although FIG. 3 illustrates that the input/output device 320 is not included in the user terminal 210, it is not limited thereto, and instead the input/output device 320 may be configured as a single device with the user terminal 210. In addition, the input/output interface 338 of the information processing system 230 may be a means for interfacing with a device (not shown) for input or output, which may be connected to the information processing system 230 or may be included in the information processing system 230. Although the input/output interface 318 or 338 is illustrated as a component configured separately from the processor 314 or 334 in FIG. 3, the input/output interface 318 or 338 is not limited thereto, and may be configured to be included in the processor 314 or 334 respectively.

The user terminal 210 and the information processing system 230 may include more components than the components shown in FIG. 3. However, it is not necessary to clearly illustrate such conventional components. According to an embodiment, the user terminal 210 may be implemented to include at least a part of the above-described input/output device 320. In addition, the user terminal 210 may further include other components such as a transceiver, a GPS (Global Positioning System) module, a camera, various sensors, a database, and the like. For example, in the case where the user terminal 210 is a smartphone, it may include general components included in a smartphone, and for example, the user terminal 210 may be implemented to further include various components such as an acceleration sensor, a gyro sensor, an image sensor, a proximity sensor, a touch sensor, an illuminance sensor, a camera module, various physical buttons, buttons using a touch panel, input/output ports, a vibrator for vibration, and the like. According to some embodiments, the processor 314 of the user terminal 210 may be configured to operate an application that provides a map information service or the like. Codes associated with the corresponding application and/or program may be loaded into the memory 312 of the user terminal 210.

While the program for providing the map information service is running, the processor 314 may receive text, images, videos, voices, and/or actions input or selected through input devices such as a touch screen, a keyboard, a camera including an audio sensor and/or an image sensor, and microphone, which are connected to the input/output interface 318, and may store the received text, images, videos, voices, and/or actions in the memory 312 or provide them to the information processing system 230 through the communication module 316 and the network 220. For example, the processor 314 may receive a user input requesting a street view image for a specific area and provide them to the information processing system 230 through the communication module 316 and the network 220.

The processor 314 of the user terminal 210 may be configured to manage, process, and/or store information and/or data received from the input/output device 320, from another user terminal, from the information processing system 230, and/or form a plurality of external systems. The information and/or data processed by the processor 314 may be provided to the information processing system 230 through the communication module 316 and the network 220. The processor 314 of the user terminal 210 may transmit information and/or data to the input/output device 320 through the input/output interface 318 and output the information and/or data. For example, the processor 314 may display the received information and/or data on a screen of the user terminal.

The processor 334 of the information processing system 230 may be configured to manage, process, and/or store information and/or data received from the plurality of user terminals 210 and/or from a plurality of external systems. The information and/or data processed by the processor 334 may be provided to the user terminal 210 through the communication module 336 and the network 220.

FIG. 4 is a drawing illustrating an example of a process for generating a visual feature map 450 associated with a street view image 420, based on a three-dimensional model 410 and a street view image 420, according to an embodiment of the invention. In this embodiment, the three-dimensional model 410 may represent a three-dimensional model for a specific area including three-dimensional geometric information expressed as absolute coordinate positions. For example, the three-dimensional model 410 may include a three-dimensional building model for buildings and a three-dimensional road model within the specific area.

In some embodiments, the street view image 420 may be a 360-degree panoramic image generated by equirectangular projection and may be a street view image captured at a specific node within the specific area. The street view image 420 may include absolute coordinate position information and direction information aligned with the absolute coordinate position information of the three-dimensional model. For example, the absolute coordinate position information and direction information included in the street view image 420 may be information aligned with the absolute coordinate position information of the three-dimensional model 410 using predefined map matching points or map matching lines.

According to an embodiment, the information processing system may render a depth map 430 associated with the street view image 420 using the three-dimensional model 410. For example, based on the absolute coordinate position information and direction information of the street view image 420, three-dimensional geometric information included in the three-dimensional model 410 may be projected onto the street view image 420 to render the depth map 430 associated with the street view image 420.

In some embodiments, the information processing system may extract a plurality of feature points 440 from the street view image 420. For example, the information processing system may convert the street view image into a plurality of planar images using a perspective projection method, and then extract a plurality of feature points 440 from the plurality of planar images. In another example, the information processing system may extract a plurality of feature points 440 using a binary mask generated based on the street view image 420.

In some embodiments, the information processing system may generate a visual feature map 450 associated with the street view image 420, based on the depth map 430 and the plurality of feature points 440 of the street view image. For example, the information processing system may determine absolute coordinate position information of the plurality of feature points 440 on the basis of the depth map 430. In addition, the information processing system may store absolute coordinate position information and a visual feature descriptor for each of the plurality of feature points 440 in association with each other, thereby generating a visual feature map 450 associated with the street view image 420.

As described above, according to certain embodiments of the present invention. 1 three-dimensional building model information generated through aerial image surveying or the like and street view images previously taken for street view services may be used, instead of using a vehicle equipped with a vehicle-based multi-sensor surveying system, thereby reducing the cost and effort for obtaining a visual feature map.

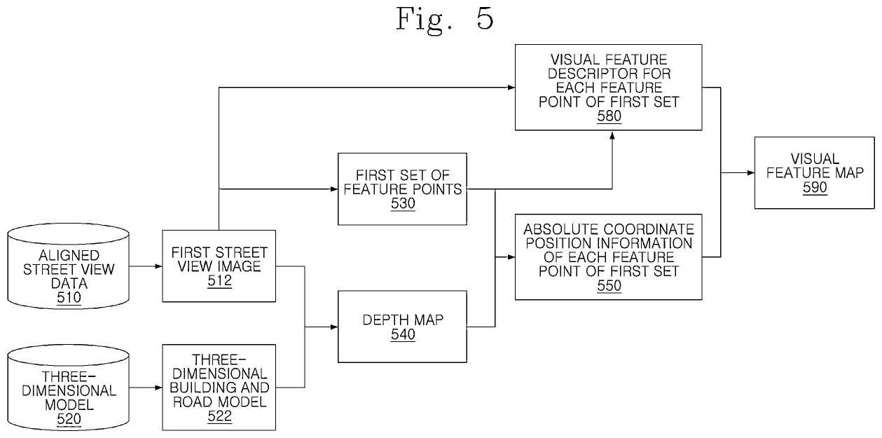

FIG. 5 is a block diagram illustrating a specific method for generating a visual feature map 590 associated with a first street view image 512, based on aligned street view data 510 and a three-dimensional model 520, according to an embodiment of the invention. Here, the aligned street view data 510 may be a plurality of street view images captured at a plurality of nodes within a specific area, and may be a panoramic image generated by equirectangular projection. In some embodiments, the aligned street view data 510 may include high-accuracy (high-precision) absolute coordinate position information and direction information aligned with the absolute coordinate position information of the three-dimensional model 410 using predefined map matching points or map matching lines. In other embodiments, the aligned street view data 510 may include absolute coordinate position information and direction information obtained from high-precision position estimation using GPS/INS (Global Positioning System/Inertial Navigation System) sensor fusion.

The three-dimensional model 520 is a model for a specific area generated based on an aerial photograph image, and may include a three-dimensional road model, a three-dimensional building model, and the like. In addition, the three-dimensional model 520 may include three-dimensional geometric information expressed as absolute coordinate positions. For example, the three-dimensional model 520 may be configured as a triangle mesh including vertices and connection information (edges), but is not limited thereto, and may be point clouds restored in three dimensions through aerial photographing, or a digital elevation model (DEM) determined through aerial surveying. Alternatively, the three-dimensional model 520 may be configured as a combination of three data structures, such as a triangle mesh, a point cloud, or a digital elevation model.

According to some embodiments, the information processing system may receive a plurality of three-dimensional building and road models 522 of a specific area included in the three-dimensional model 520 for the specific area. In addition, the information processing system may receive a first street view image 512 captured at a first node within a specific area, which is included in the aligned street view data 510. Then, the information processing system may project at least some of the three-dimensional geometric information included in the three-dimensional building and road model 522 onto the first street view image 512, based on the absolute coordinate position information and direction information of the first street view image 512, to render/generate a depth map 540 associated with the first street view image 512. Here, the depth map 540 may include depth information about buildings and roads.

In certain embodiments, the information processing system may extract a first set of feature points 530 from the first street view image 512. Specifically, the information processing system may detect a first set of feature points 530 from the first street view image 512 and extract a visual descriptor 580 for each of the first set of feature points. In order to resolve errors in feature detection or feature matching due to geometric distortion of the street view image, which is a panoramic image, the information processing system may extract a first set of feature points 530 from a plurality of planar images generated based on the first street view image 512. For example, the information processing system may horizontally rotate the first street view image 512 to a height facing the horizon, project it into twelve planar images, detect feature points from each planar image, and then extract visual descriptors. The first set of feature points 530 may be extracted using SIFT (Scale-Invariant Feature Transform), SuperPoint, R2D2 (Repeatable and Reliable Detector and Descriptor) techniques, but the invention is not limited thereto.

According to some embodiments, the information processing system may determine absolute coordinate position information 550 of each feature point of the first set on the basis of the depth map 540. Then, the information processing system may generate a visual feature map 590 associated with the first street view image 512 by associating the absolute coordinate position information 550 of each feature point of the first set and the visual descriptor 580 of each feature point of the first set with each other and storing the same.

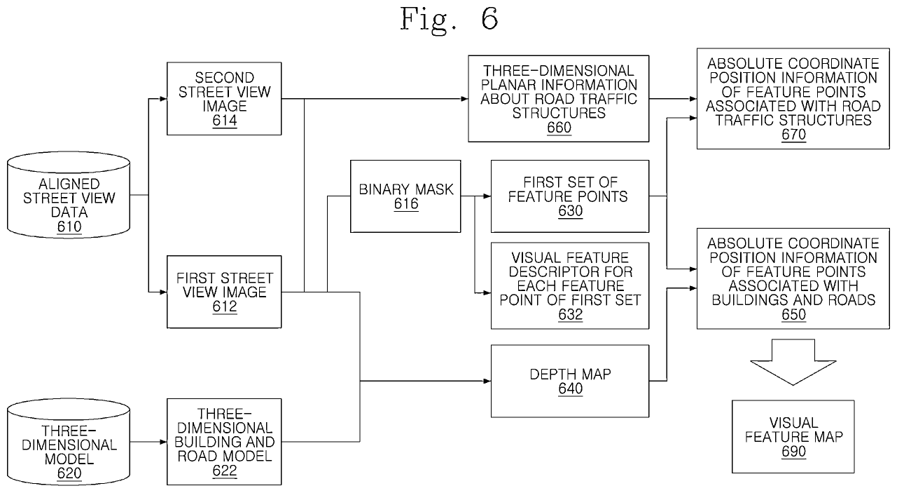

FIG. 6 is a block diagram illustrating a specific method for generating a visual feature map 690 associated with a first street view image 612, based on aligned street view data 610, a three-dimensional model 620, a binary mask 616, and three-dimensional planar information 660 about road traffic structures, according to another embodiment of the present invention. The configurations that have already been described in FIG. 5 will be briefly described or omitted based on the embodiment illustrated in FIG. 6.

According to this embodiment, the information processing system may extract a first set of feature points 630 associated with buildings and roads, based on a first street view image 612, using a binary mask 616. Specifically, the information processing system may perform semantic segmentation, based on the first street view image 612, to generate a binary mask 616 representing a road area and a building area included in the first street view image. In another example, the binary mask 616 may represent a road area, a building area, and a road traffic structure area included in the first street view image.

In certain embodiments, the information processing system may convert the first street view image 612 into a plurality of undistorted planar images. For example, the information processing system may convert the first street view image 612 into six cube images of top, bottom, left, right, up, and down through cube mapping. Thereafter, the information processing system may perform semantic segmentation on the plurality of undistorted planar images to detect road areas, building areas, vehicles, lanes, and road traffic structures (e.g., traffic lights, signs, and the like). The information processing system may merge the semantic segmentation results for plurality of undistorted planar images back into a panoramic image to generate a binary mask 616 representing road areas and building areas in the first street view image 612.

In some embodiments, the information processing system may detect a first set of feature points 630 from the first street view image 612 using the binary mask 616 and extract a visual descriptor 632 for each of the first set of feature points. For example, the information processing system may extract a first set of feature points 630 from a partial area of the first street view image 612 using the binary mask 616. As another example, the information processing system may extract a plurality of feature points from the first street view image 612 and perform filtering on the plurality of extracted feature points using the binary mask 616, thereby extracting a first set of feature points 630. Here, the first set of feature points may be feature points extracted from the road area and building area of the first street view image 612, or feature points extracted from the road area, building area, and road traffic structures.

According to some embodiments, the information processing system may determine absolute coordinate position information 670 of feature points associated with road traffic structures using a plurality of street view images 612 and 614. Here, the road traffic structures may indicate structures and/or facilities associated with driving on a road, such as signs, traffic lights, and median strips. Specifically, the information processing system, based on a first street view image 612 captured at a first node and a second street view image 614 captured at a second node within the specific area, may generate three-dimensional planar information 660 for road traffic structures included in both the first street view image 612 and the second street view image 614.

In addition, the information processing system may project feature points associated with the road traffic structures, among the first set of feature points 630, onto a three-dimensional plane to determine absolute coordinate position information 670 of the feature points associated with the road traffic structures. Through this configuration, even if the three-dimensional model 620 does not include position information about road traffic structures, the information processing system may obtain absolute coordinate position information of the road traffic structures included in both the first street view image 612 and the second street view image 614.

According to some embodiments, the information processing system may determine absolute coordinate position information 650 of feature points associated with buildings and roads, based on the depth map 640. Here, the depth map 640 may represent the depth map 640 generated by the method described with reference to FIG. 5. For example, the information processing system may determine absolute coordinate position information 650 of feature points associated with buildings and roads, among the first set of feature points 630, using the depth map 640 including depth information of buildings and roads.

In some embodiments, the information processing system may store absolute coordinate position information 670 of feature points associated with road traffic structures, among the first set of feature points 630, absolute coordinate position information 650 of feature points associated with buildings and roads, among the first set of feature points 630, and the visual descriptor 632 of each of the first set of feature points in association with each other, thereby generating a visual feature map 690 associated with the first street view image 612.

Although FIG. 6 illustrates an example of determining absolute coordinate position information 650 of feature points associated with buildings and roads using a depth map 640 including depth information of buildings and roads generated based on a three-dimensional building and road model 622, the invention is not limited thereto. For example, the three-dimensional building and road model 622 may further include some or all of the road traffic structures associated with road driving, and in this case, the depth map 640 may include depth information for some or all of the road traffic structures as well as the roads and buildings. In this case, the absolute coordinate position information 650 of feature points associated with the buildings and the roads may also include absolute coordinate position information 650 of feature points associated with some or all of the road traffic structures as well as the roads and the buildings.

Although a method of generating a visual feature map 690 for buildings, roads, and road traffic structures using the binary mask 616 and the three-dimensional planar information 660 for the road traffic structures is illustrated in FIG. 6, some of these processes may be omitted. For example, a visual feature map 690 for buildings, road, and road traffic structures may be generated without using the binary mask 616. As another example, a visual feature map 690 for buildings and roads may be generated without generating three-dimensional planar information 660 for road traffic structures.

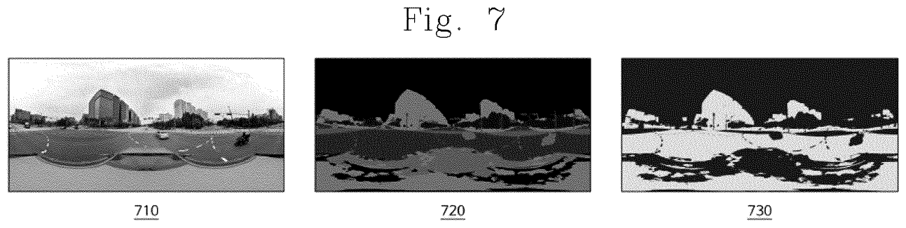

FIG. 7 is a diagram illustrating an example of a process for generating a binary mask, based on a street view image, according to an embodiment of the invention. The information processing system may generate a binary mask, based on a street view image, through a first state 710, a second state 720, and a third state 730. The first state 710 shows an example of a street view image captured at a specific node within a specific area. Here, the street view image may be a 360-degree panoramic image generated by equirectangular projection.

The second state 720 shows an example of a result of semantic segmentation performed based on the street view image. In certain embodiments, the information processing system may perform semantic segmentation by converting the street view image into a plurality of undistorted planar images. For example, the information processing system may convert the street view image into six cube images using the perspective projection method, thereby performing semantic segmentation. As another example, the information processing system may perform semantic segmentation on the street view image all at once. Semantic segmentation may be performed using techniques such as deeplab v3, mask-rcnn, or the like, but it is not limited thereto.

The third state 730 shows an example of a binary mask obtained as a result of performing semantic segmentation on the street view image. According to this embodiment, the binary mask may represent a road area and a building area in the street view image.

In certain embodiments, the information processing system may extract a first set of feature points from the street view image using the binary mask. For example, the information processing system may extract a first set of feature points from a partial area of the street view image using the binary mask. Here, the partial area of the street view image may be an area corresponding to the binary mask. As another example, the information processing system may extract a first set of feature points from an area corresponding to the binary mask by performing filtering on a plurality of feature points extracted from the entire area of the street view image using the binary mask.

Although the binary mask is illustrated as representing the road and building areas of the street view image in FIG. 7, it is not limited thereto. For example, the binary mask may represent a road area, a building area, and a road traffic structure area of the street view image.

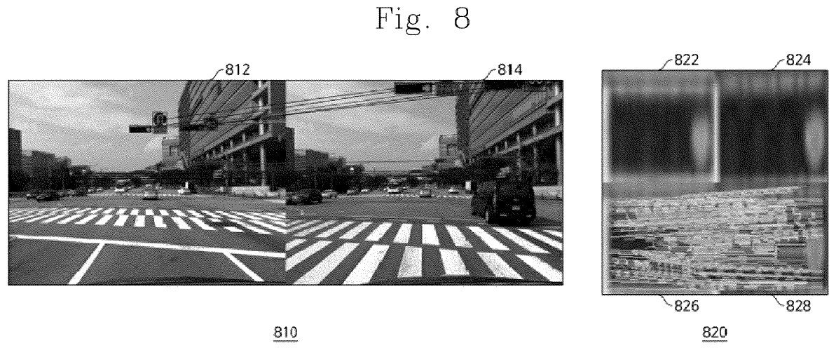

FIG. 8 is a diagram illustrating an example of a process for performing stereo matching for road traffic structures in a first street view image 812 and a second street view image 814 according to an embodiment of the invention. In this embodiment, when a visual feature map associated with a street view is generated using a depth map including depth information of a building and a road generated based on a three-dimensional building and road model, absolute coordinate position information for road traffic structures associated with a driving environment in the street view may be missing. To solve this, an information processing system may generate three-dimensional planar information for road traffic structures, based on a plurality of street view images 812 and 814, and it may obtain absolute coordinate position information associated with the road traffic structures.

In certain embodiments, in order to obtain absolute coordinate position information associated with road traffic structures, the information processing system may generate three-dimensional planar information about a specific road traffic structure included in each of the plurality of street view images 812 and 814, based on the plurality of street view images 812 and 814. For example, the information processing system may generate three-dimensional planar information about a specific road traffic structure included in the first street view image 812 and the second street view image 814 through the first state 810 and the second state 820. Here, the first street view image 812 and the second street view image 814 may be images captured from adjacent nodes.

The first state 810 represents an example of a result of detecting an area including road traffic structures in the first street view image 812 and the second street view image 814 and determining a relationship between the same road traffic structures. In this embodiment, the information processing system may detect a first area including a first road traffic structure (e.g., a traffic light) from the first street view image 812. Similarly, the information processing system may detect a second area including a second road traffic structure (e.g., the same traffic light) from the second street view image 814. For example, as illustrated, the information processing system may detect a four-color traffic light from the first street view image 812 as a first area, and a four-color traffic light from the second street view image 814 as a second area. Then, the information processing system may determine that the first area and the second area contain the same road traffic structure and determine a relationship between them. For example, the information processing system may determine that the first road traffic structure and the second road traffic structure are the same road traffic structure (e.g., the same traffic light), based on the visual similarity of the first area and the second area. Here, the visual similarity of the first area and the second area may be determined using at least one of color similarity, visual feature descriptor similarity, or a deep learning-based matching model.

The second state 820 shows an example of the results 826 and 828 of performing stereo matching between the first area and the second area to generate three-dimensional planar information for a specific road traffic structure. In the case of road traffic structures, it is necessary to specify road traffic structures to be matched with each other because the structures, forms, and shapes thereof are similar. To this end, the information processing system may divide the first area of the first street view image 812 into a first area image 822. Similarly, the information processing system may divide the second area of the second street view image 814 into a second area image 824. Then, dense stereo matching and triangulation may be performed on the first area image 822 and the second area image 824 to obtain depth information of the matched road traffic structure. As a result, the information processing system may generate three-dimensional planar information for the same road traffic structure (e.g., the 4-color traffic light) included in both the first street view image 812 and the second street view image 814.

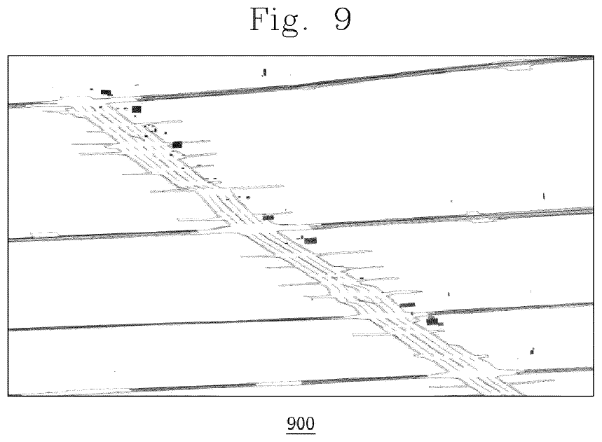

FIG. 9 is an example of a three-dimensional planar information map 900 for a plurality of road traffic structures according to an embodiment of the invention. Here, the three-dimensional planar information map 900 for a plurality of road traffic structures may represent information visualized by merging three-dimensional planar information for each of the plurality of road traffic structures obtained from a plurality of street view images captured at different nodes. As shown in FIG. 9, the road traffic structures may include, but are not limited to, road traffic signs, safety signs, and traffic lights. For example, the road traffic structures may further include structures or facilities that may affect the road driving environment, such as median strips, curbs, street trees, bus stops, or the like. Such road traffic structures are objects that do not change visually much over time, and are suitable objects for use in camera-based position estimation after a visual feature map is generated.

According to certain embodiments, three-dimensional planar information for a specific road traffic structure may be used to determine absolute coordinate position information of feature points associated with the road traffic structure, among a plurality of feature points in a street view image. In some embodiments, the information processing system may project feature points associated with a specific road traffic structure, among the plurality of feature points in the street view image, onto a three-dimensional plane, thereby determining absolute coordinate position information of the feature points associated with a specific road traffic structure.

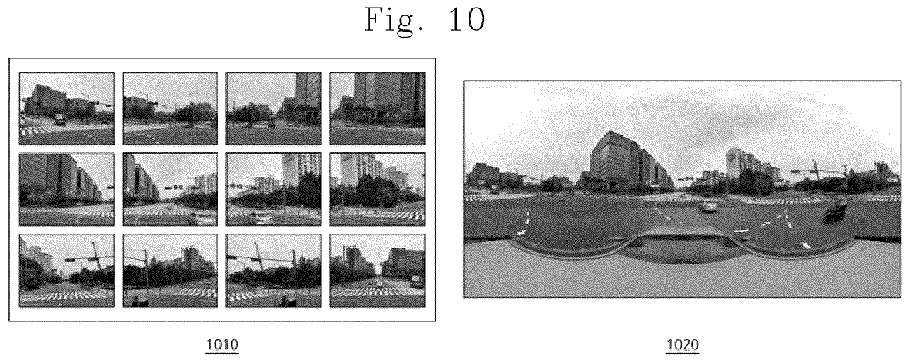

FIG. 10 is an example of a process for extracting a first set of feature points from a street view image using a plurality of planar images generated based on a street view image according to an embodiment of the invention. Here, the street view image may be a 360-degree panoramic image generated by equirectangular projection, and may be a street view image captured at a specific node within a specific area. In order to resolve errors in feature detection or feature matching due to geometric distortion of the street view image, which is a panoramic image, the information processing system may extract a first set of feature points from the street view image through a first state 1010 and a second state 1020.

The first state 1010 shows an example of a plurality of planar images generated based on the street view image. According to this embodiment, the information processing system may convert the first street view image into a plurality of planar images using a perspective projection method. Thereafter, the information processing system may extract a plurality of feature points from each of the plurality of planar images. For example, as illustrated, the information processing system may horizontally rotate the street view image to a height facing the horizon, project it into twelve planar images, detect feature points from each planar image, and extract visual descriptors. In the first state 1010, one red dot may represent one feature point.

The second state 1020 shows an example of the result of projecting the feature points extracted from the plurality of planar images onto the street view image. According to this embodiment, the information processing system may obtain a first set of feature points by projecting coordinate information associated with a plurality of feature points in each of the plurality of planar images onto the street view image. For example, the information processing system may obtain a first set of feature points in the street view image by projecting coordinate information associated with a plurality of feature points extracted from each of the plurality of planar images in the first state 1010 onto the street view image using an inverse calculation of the perspective projection method. In the second state 1020, one red dot may represent one feature point.

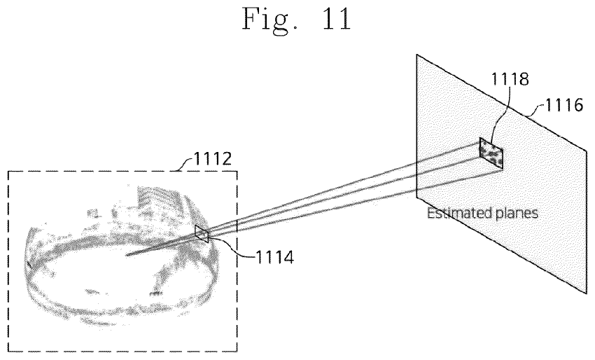

FIG. 11 is an example of a process for obtaining absolute coordinate position information for road traffic structures according to an embodiment of the invention. According to this embodiment, the information processing system may determine absolute coordinate position information of feature points 1114 associated with a road traffic structure using three-dimensional planar information 1116 for a specific road traffic structure obtained by the method described with reference to FIG. 8. Feature points indicated by green dots in the street view image 1112 may represent feature points associated with buildings and roads, and feature points indicated by red dots may represent feature points associated with road traffic structures.

In some embodiments, the information processing system may project feature points 1114 associated with road traffic structures, among a plurality of feature points extracted from the street view image 1112, onto a three-dimensional plane 1116 for the road traffic structures. Thereafter, the information processing system may determine three-dimensional coordinate information of feature points 1118 projected onto the three-dimensional plane 1116, based on information of the three-dimensional plane 1116.

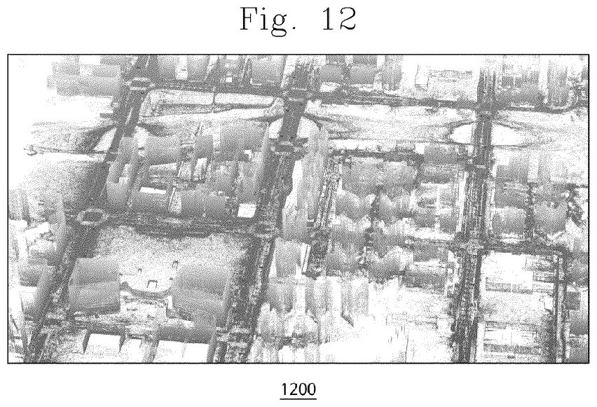

FIG. 12 illustrates an example of a visual feature map 1200 for a specific area according to an embodiment of the invention. According to this embodiment, the information processing system may generate a visual feature map 1200 for a specific area by merging visual feature maps associated with a plurality of street view images captured at different nodes of the specific area. For example, the information processing system may generate a first visual feature map associated with a first street view, based on a first street view image captured at a first node in the specific area. Similarly, the information processing system may generate a second visual feature map associated with a second street view image, based on a second street view image captured at a second node in the specific area. Then, the information processing system may merge the first visual feature map and the second visual feature map, based on absolute coordinate position information and direction information of the first street view image and absolute coordinate position information and direction information of the second street view image, to generate a visual feature map 1200 for the specific area. Here, the absolute coordinate position information and direction information of the first street view image, and the absolute coordinate position information and direction information of the second street view image may be information aligned with the absolute coordinate position information of the three-dimensional model.

In the visual feature map 1200, the feature points indicated by green dots may represent feature points associated with buildings and roads, and the feature points indicated by red dots may represent feature points associated with road traffic structures. Through this configuration, three-dimensional building model information generated through aerial image surveying or the like and street view images previously taken for street view services may be used, instead of using a vehicle equipped with a vehicle-based multi-sensor surveying system, to obtain the entire visual feature map for a specific area, thereby reducing the cost and effort therefor.

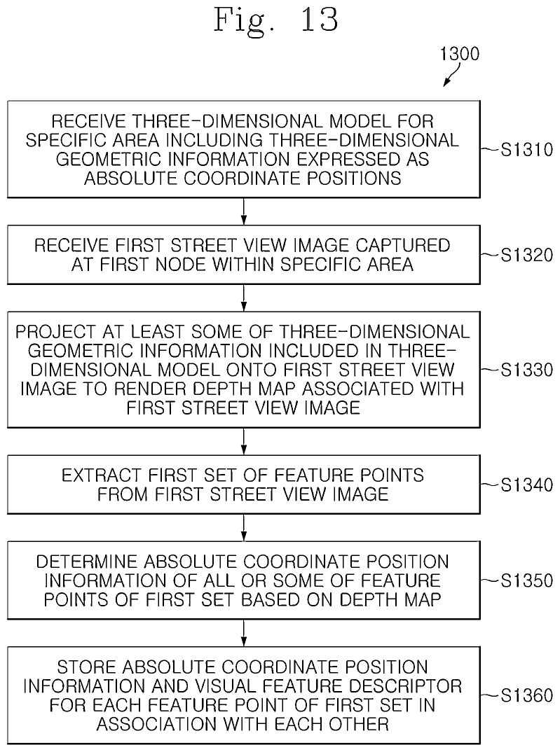

FIG. 13 is a flowchart illustrating an example of a visual feature map generation method 1300 using a three-dimensional model and a street view image. The method 1300 may be initiated by a processor (e.g., at least one processor of an information processing system) receiving a three-dimensional model for a specific area, which includes three-dimensional geometric information expressed as absolute coordinate positions (S1310). Here, the three-dimensional model may include a plurality of three-dimensional building models and road models within the specific area.

Thereafter, the information processing system may receive a first street view image captured at a first node within the specific area (S1320). Here, the first street view image may be a panoramic image generated by equirectangular projection. In addition, absolute coordinate position information and direction information of the first street view image may be position information aligned with the absolute coordinate position information of the three-dimensional model. For example, the absolute coordinate position information and direction information of the first street view image may be aligned with the absolute coordinate position information of the three-dimensional model using a predefined map matching point or map matching line. Here, the map matching point may include a ground control point (GCP) and a building control point (GCP). Each ground control point may form a corresponding pair with a point on the ground in the three-dimensional absolute coordinate position information. Each building control point may form a corresponding pair with a point on the building in three-dimensional absolute coordinate position information. The map matching line may include a ground control line (GCL), and each ground control line may form a corresponding pair with a line on the ground in at least one piece of three-dimensional absolute coordinate position information.

In some embodiments, the information processing system may project at least some of the three-dimensional geometric information included in the three-dimensional model onto the first street view image, based on the absolute coordinate position information and direction information of the first street view image, to render a depth map associated with the first street view image (S1330). Here, the depth map may include depth information of buildings and roads.

In an embodiment, the information processing system may extract a first set of feature points from the first street view image (S1340). For example, the information processing system may convert the first street view image into a plurality of planar images using a perspective projection method, extract a plurality of feature points from each of the plurality of planar images, and project coordinate information associated with the plurality of feature points in each of the plurality of planar images onto the first street view image, thereby obtaining a first set of feature points.

In some embodiments, the information processing system may perform semantic segmentation, based on the first street view image, to generate a binary mask representing a road area and a building area included in the first street view image, and extract a first set of feature points from the first street view image using the binary mask. In this case, generating the binary mask may include converting the first street view image into a plurality of undistorted planar images and performing semantic segmentation on the plurality of undistorted planar images to detect a road area and a building area. Here, the plurality of undistorted planar images may be generated by converting the first street view image into six cube images using a perspective projection method. In addition, extracting the first set of feature points from the first street view image using the binary mask may include extracting the first set of feature points from a partial area of the first street view image using the binary mask. Alternatively, extracting the first set of feature points from the first street view image using the binary mask may include performing filtering on the plurality of feature points extracted from the first street view image using the binary mask to extract the first set of feature points.

In some embodiments, the information processing system may determine absolute coordinate position information of all or some of the feature points of the first set, based on the depth map (S1350). Specifically, absolute coordinate position information of feature points associated with buildings and roads, among the first set of feature points, may be determined based on the depth map.

In some embodiments, the information processing system may receive a second street view image captured at a second node within a specific area. In this case, the information processing system may generate three-dimensional planar information for a specific road traffic structure included in the first street view image and the second street view image, based on the first street view image and the second street view image. Here, generating the three-dimensional planar information may include detecting a first area including a first road traffic structure in the first street view image, detecting a second area including a second road traffic structure in the second street view image, determining the first road traffic structure and the second road traffic structure to be a specific road traffic structure, as the same road traffic structure, based on visual similarity between the first area and the second area, and performing stereo matching and triangulation on the first area and the second area to generate the three-dimensional planar information for the specific road traffic structure. Here, the visual similarity between the first area and the second area may be determined using at least one of color similarity, visual feature descriptor similarity, or a deep learning-based matching model. Thereafter, the information processing system may determine absolute coordinate position information of feature points associated with the specific road traffic structure, among the first set of feature points, based on the three-dimensional planar information. For example, determining the absolute coordinate position information of the feature points associated with a specific road traffic structure may include projecting the feature points associated with the specific road traffic structure, among the first set of feature points, onto a three-dimensional plane.

Thereafter, the information processing system may generate a first visual feature map associated with the first street view image by associating the absolute coordinate position information and the visual feature descriptor for each feature point of the first set and storing the same (S1360).

In some embodiments, the information processing system may receive a second street view image captured at a second node within the specific area, and generate a second visual feature map associated with the second street view image. Thereafter, the information processing system may merge the first visual feature map and the second visual feature map, based on the absolute coordinate position information and direction information of the first street view image and the absolute coordinate position information and direction information of the second street view image. Here, the absolute coordinate position information and direction information of the first street view image and the absolute coordinate position information and direction information of the second street view image may be position information aligned with the absolute coordinate position information of the three-dimensional model.

The flowchart in FIG. 13 and the above description are only examples, and the scope of the invention is not limited thereto. For example, at least one step may be added/changed/deleted, or the order of the steps may be changed.

The above-described method may be provided as a computer program stored on a computer-readable recording medium for execution on a computer. In addition, the medium may be a variety of recording means or storage means in the form of a single piece of hardware or a combination of multiple pieces of hardware, and may not be limited to a medium directly connected to a computer system, but may also be distributed on a network. Examples of the medium may include a magnetic medium such as a hard disk, a floppy disk, and a magnetic tape, an optical recording medium such as a CD-ROM and DVD, a magneto-optical medium such as a floptical disk, and a ROM, a RAM, a flash memory, or the like, configured to store program instructions. In addition, other examples of the medium may include a recording medium or storage medium managed by an App Store that distributes applications, or sites or servers that supply or distribute various software.

The methods, operations, or techniques of the disclosure may be implemented by various means. For example, these techniques may be implemented in hardware, firmware, software, or a combination thereof. It will be appreciated by those skilled in the art that the various exemplary logical blocks, modules, circuits, and algorithm steps described in connection with the disclosure herein may be implemented as electronic hardware, computer software, or a combination thereof. To clearly illustrate this interchangeability of hardware and software, various exemplary components, blocks, modules, circuits, and steps have been described above generally in terms of their functions. Whether or not such functions are implemented as hardware or software will depend upon specific applications and design requirements imposed on the overall system. It will be appreciated that those skilled in the art may implement the functions described in a variety of ways for each specific application, but such implementations should not be construed as causing a departure from the scope of the disclosure.

In a hardware implementation, the processing units used to perform the techniques may be implemented as one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the disclosure, computers, or a combination thereof.

Accordingly, the various exemplary logic blocks, modules, and circuits described in connection with the disclosure may be implemented as or performed by general-purpose processors, DSPs, ASICs, FPGAs or other programmable logic devices, discrete gates or transistor logics, discrete hardware components, or a combination of configurations designed to perform the functions described herein. The general-purpose processor may be a microprocessor, and alternatively, the processor may be any conventional processor, controller, microcontroller, or state machine. The processor may also be implemented as a combination of computing devices, for example, a combination of a DSP and a microprocessor, a plurality of microprocessors, one or more microprocessors in conjunction with a DSP core, or any other configurations.

In implementation of firmware and/or software, the techniques may be implemented as instructions stored on a computer-readable medium, such as a random-access memory (RAM), a read-only memory (ROM), a non-volatile random-access memory (NVRAM), a programmable read-only memory (PROM), an erasable programmable read-only memory (EPROM), an electrically erasable PROM (EEPROM), a flash memory, a compact disc (CD), a magnetic or optical data storage device, or the like. The instructions may be executable by one or more processors and may cause the processor(s) to perform certain aspects of the functions described in the disclosure.

Although the embodiments have been described above as utilizing aspects of the presently disclosed subject matter in one or more standalone computer systems, the disclosure is not limited thereto, and may be implemented in conjunction with any computing environment, such as a network or distributed computing environment. Furthermore, aspects of the subject matter in the disclosure may be implemented in a plurality of processing chips or devices, and storage may be similarly affected across a plurality of devices. Such devices may include PCs, network servers, and portable devices.

Although the disclosure has been described herein with respect to certain embodiments, it will be appreciated that various modifications and variations may be made without departing from the scope of the disclosure, which may be understood by those skilled in the art to which the disclosure pertains. Furthermore, such modifications and variations should be considered to fall within the scope of the claims appended hereto.

What is claimed is:

1. A method for generating a visual feature map using a three-dimensional model and a street view image, performed by at least one processor, the method comprising:
receiving a three-dimensional model for a specific area including three-dimensional geometric information expressed as absolute coordinate positions;
receiving a first street view image captured at a first node within the specific area;
projecting at least some of the three-dimensional geometric information included in the three-dimensional model onto the first street view image, based on absolute coordinate position information and direction information of the first street view image, to render a depth map associated with the first street view image;
extracting a first set of feature points from the first street view image;
determining absolute coordinate position information of at least some of the first set of feature points, based on the depth map; and
generating a first visual feature map associated with the first street view image by storing, for each of the feature points in the first set, the absolute coordinate position information and a visual feature descriptor in association with each other.

2. The method for generating a visual feature map of claim 1,
wherein the first street view image is a panoramic image generated by equirectangular projection, and
wherein the absolute coordinate position information and direction information of the first street view image are aligned with absolute coordinate position information of the three-dimensional model.

3. The method for generating a visual feature map of claim 1,
wherein the extracting of the first set of feature points comprises:
performing semantic segmentation on the first street view image to generate a binary mask representing a road area and a building area included in the first street view image; and
extracting the first set of feature points from the first street view image using the binary mask.

4. The method for generating a visual feature map of claim 3,
wherein the generating of the binary mask comprises:
converting the first street view image into a plurality of undistorted planar images; and
performing semantic segmentation on the plurality of undistorted planar images to detect a road area and a building area.

5. The method for generating a visual feature map of claim 4,
wherein the plurality of undistorted planar images are generated by converting the first street view image into six cube images using a perspective projection method.

6. The method for generating a visual feature map of claim 1,
wherein the three-dimensional model comprises a plurality of three-dimensional building models and road models within the specific area,
wherein the depth map comprises depth information of buildings and the roads, and
wherein absolute coordinate position information of feature points associated with buildings and roads, among the first set of feature points, is determined based on the depth map.

7. The method for generating a visual feature map of claim 3,
wherein the extracting of the first set of feature points from the first street view image using the binary mask comprises
extracting the first set of feature points from a partial area of the first street view image using the binary mask.

8. The method for generating a visual feature map of claim 3,
wherein the extracting of the first set of feature points from the first street view image using the binary mask comprises:
performing filtering on a plurality of feature points extracted from the first street view image using the binary mask to extract the first set of feature points.

9. The method for generating a visual feature map of claim 1, further comprising:
receiving a second street view image captured at a second node within the specific area;
generating three-dimensional planar information for a specific road traffic structure included in the first street view image and the second street view image, based on the first street view image and the second street view image; and
determining absolute coordinate position information of feature points associated with the specific road traffic structure, among the first set of feature points, based on the three-dimensional planar information.

10. The method for generating a visual feature map of claim 9,
wherein the determining of the absolute coordinate position information of feature points associated with the specific road traffic structure comprises:
projecting the feature points associated with the specific road traffic structure, among the first set of feature points, onto the three-dimensional plane.

11. The method for generating a visual feature map of claim 9,
wherein the generating of the three-dimensional planar information comprises:
detecting a first area including a first road traffic structure from the first street view image;
detecting a second area including a second road traffic structure from the second street view image;
determining the first road traffic structure and the second road traffic structure to be the specific road traffic structure, as the same road traffic struct, based on visual similarity between the first area and the second area; and
performing stereo matching and triangulation on the first area and the second area to generate three-dimensional planar information for the specific road traffic structure.

12. The method for generating a visual feature map of claim 11,
wherein the visual similarity between the first area and the second area is determined using at least one of color similarity, visual feature descriptor similarity, or a deep learning-based matching model.

13. The method for generating a visual feature map of claim 1,
wherein the extracting of the first set of feature points comprises:
converting the first street view image into a plurality of planar images using a perspective projection method;
extracting a plurality of feature points from each of the plurality of planar images; and
obtaining the first set of feature points by projecting coordinate information associated with the plurality of feature points in each of the plurality of planar images onto the first street view image.

14. The method for generating a visual feature map of claim 1,
wherein the absolute coordinate position information and direction information of the first street view image are aligned with the absolute coordinate position information of the three-dimensional model using a predefined map matching point or map matching line.

15. The method for generating a visual feature map of claim 14,
wherein the map matching point comprises a ground control point (GCP) and a building control point (GCP),
wherein each ground control point forms a corresponding pair with a point on the ground in three-dimensional absolute coordinate position information, and
wherein each building control point forms a corresponding pair with a point on the building in three-dimensional absolute coordinate position information.

16. The method for generating a visual feature map of claim 14,
wherein the map matching line comprises a ground control line (GCL), and
wherein each ground control line forms a corresponding pair with a line on the ground in at least one piece of three-dimensional absolute coordinate position information.

17. The method for generating a visual feature map of claim 1, further comprising:
receiving a second street view image captured at a second node within the specific area;
generating a second visual feature map associated with the second street view image; and
based on the absolute coordinate position information and direction information of the first street view image and absolute coordinate position information and direction information of the second street view image, merging the first visual feature map and the second visual feature map,
wherein the absolute coordinate position information and direction information of the first street view image and the absolute coordinate position information and direction information of the second street view image are aligned with absolute coordinate position information of the three-dimensional model.

18. A non-transitory computer-readable recording medium recording instructions for executing the method according to claim 1 on a computer.

19. An information processing system comprising:
a communication module;
a memory; and
at least one processor connected to the memory and configured to execute at least one computer-readable program included in the memory,
wherein the at least one program comprises instructions for:
receiving a three-dimensional model for a specific area including three-dimensional geometric information expressed as absolute coordinate positions;
receiving a first street view image captured at a first node within the specific area;
projecting at least some of the three-dimensional geometric information included in the three-dimensional model onto the first street view image, based on absolute coordinate position information and direction information of the first street view image, to render a depth map associated with the first street view image;
extracting a first set of feature points from the first street view image;
determining absolute coordinate position information of at least some of the first set of feature points, based on the depth map; and
generating a first visual feature map associated with the first street view image by storing, for each of the feature points in the first set, the absolute coordinate position information and a visual feature descriptor in association with each other.
